(19) United States
(12) Patent Application Publication
(10) Pub. No.: US 2002/0149624 A1
(43) Pub. Date: Oct. 17, 2002

(54) Method of setting up a display window

(75) Inventors: Kyoung Woo Lee, Seoul (KR); Sang Hyup Lee, Seoul (KR); ByungDal Jung, Anyang-si (KR)

Correspondence Address: JONATHAN Y. KANG, ESQ., LEE & HONG P.C., 11th Floor, 221 N. Figueroa Street, Los Angeles, CA, 90012-2601, US

(73) Assignee: LG Electronics Inc.

(21) Appl. No.: 10/120,663

(22) Filed: Apr. 11, 2002

(30) Foreign Application Priority Data
Apr. 11, 2001 (KR) 19326/2001

(51) Int. Cl. G09G 5/00

(52) U.S. Cl. 345/765

(57) ABSTRACT

A method of setting up a display window is provided. The method comprises the steps of selecting an editor menu so as to set up a showdow, determining whether the showdow is selected from fundamental forms setting on the editor, setting a size of a multimedia message displayed on the showdow, determining whether the multimedia message is entirely contained by the showdow, and displaying the size-set multimedia message on the showdow.

### BACKGROUND OF THE INVENTION

1. Field of the Invention

The present invention relates to a method of setting up a display window, and more particularly to a method of setting up the geometrical shape of a display window, in which a multimedia message can be reproduced in various-shaped forms of display windows.

2. Description of the Related Art

As well known to those skilled in the art, the rapid progress of information communication technology and the computer industry allow us to enjoy the reproduction of multimedia messages provided via computers, televisions, digital televisions and terminals using a wireless communication network, regardless of time and place.

For example, multimedia messages can be transmitted from an internet broadcasting station and reproduced anywhere in real-time mode by videos, audios, etc.

Through standardized Synchronized Multimedia Integration Language (SMIL), Hyper Text Markup Language (HTML), or so on, not only one type of multimedia data, but also plural types of the multimedia data such as video, audio, animation, and image data can be reproduced together with text. Particularly, this mode is widely used in broadcasting and education fields.

FIGS. 1a to 1d are views, each showing a conventional display window, respectively.

With reference to FIGS. 1a to 1d, the conventional display widows are all rectangular in shape, with a designated size. Particularly, FIG. 1c is a reproduction screen of a SMIL player supporting a synchronized reproducing of multimedia data.

The conventional multimedia message reproduction technology is embodied only within a rectangular display window.

However, if necessary, shapes of the display window for reproducing the multimedia messages need to be determined by contents, data types, or a human optical characteristic. For example, a screen for installation in vehicles requiring the impression of depth may be embodied in an elliptical display window. Thereby, a driver of the vehicle, i.e., a viewer of the screen, can have the impression of dynamic motion.

### SUMMARY OF THE INVENTION

Therefore, the present invention has been made in view of the above problems, and it is an object of the present invention to provide a method of setting up the geometrical shape of a display window, in which a multimedia message can be reproduced in various-shaped forms of display windows by selecting one from plural fundamental forms of the geometrical shape of the display window set up at an editor or by creating any new form of a display window pursuant to a user's desire.

In accordance with one aspect of the present invention, the above and other objects can be accomplished by the provision of a method of setting up a display window, the method comprising the steps of selecting an editor menu so as to set up a showdow, determining whether the showdow is selected from fundamental forms setting on the editor, setting a size of a multimedia message displayed on the showdow, determining whether the multimedia message is entirely contained by the showdow, and displaying the size-set multimedia message on the showdow.

Preferably, if the showdow is formed by a straight line, and at least three points represented by values of a x-axis and y-axis may be set, thereby forming the showdow.

Further, if the showdow is formed by a curved line, a central point represented by values of X-axis and Y-axis is set and values of X-axis and Y-axis of two points symmetrically spaced from the central point and on one straight line with the central point may be set. Then, each of the two points may be connected in a curved line to the central point.

Preferably, A visible area for displaying the multimedia message to the user may be changed by the size of the multimedia message displayed on the showdow.

Preferably, if the multimedia message is entirely contained by the showdow, any one is selected from predetermined background colors or background images, then displayed on an area of the showdow except for the area of the multimedia message.

And, if the showdow is entirely contained by the multimedia message, any one is selected from predetermined background colors or background images, then displayed on an area of the multimedia message on the outside of the showdow.

Further, if the size of the multimedia message displayed on the showdow is set as any value between 0 and 100, any one is selected from predetermined background colors or background images, then displayed on an area of the showdow except for the multimedia message and an area of the multimedia message except for the showdow.

### BRIEF DESCRIPTION OF THE DRAWINGS

The above and other objects, features and other advantages of the present invention will be more clearly understood from the following detailed description taken in conjunction with the accompanying drawings. Understanding that these drawings depict only typical embodiments of the invention, the invention will be described with additional specificity and detail through use of the accompanying drawings, in which:

FIGS. 1a to 1d are views, each showing a conventional display window, respectively;

FIG. 2 is a flow chart illustrating a method of setting up a display window in accordance with the present invention;

FIGS. 3a to 3e are views, each showing a method of selecting a shape of a display window from fundamental forms in accordance with a preferred embodiment of the present invention;

FIGS. 4a to 4c are views, each showing a method of creating a new shape of a display window pursuant to the user's desire in accordance with another preferred embodiment of the present invention; and

FIGS. 5a to 5c are views showing a method of displaying multimedia messages on a predetermined-shaped display window in accordance with the present invention.

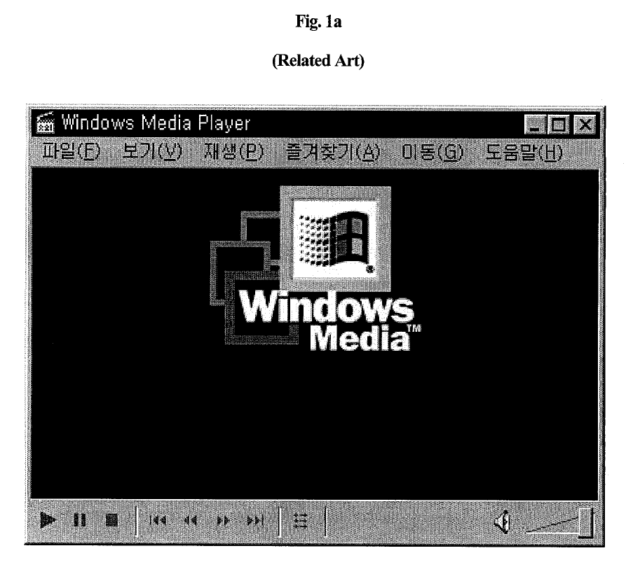

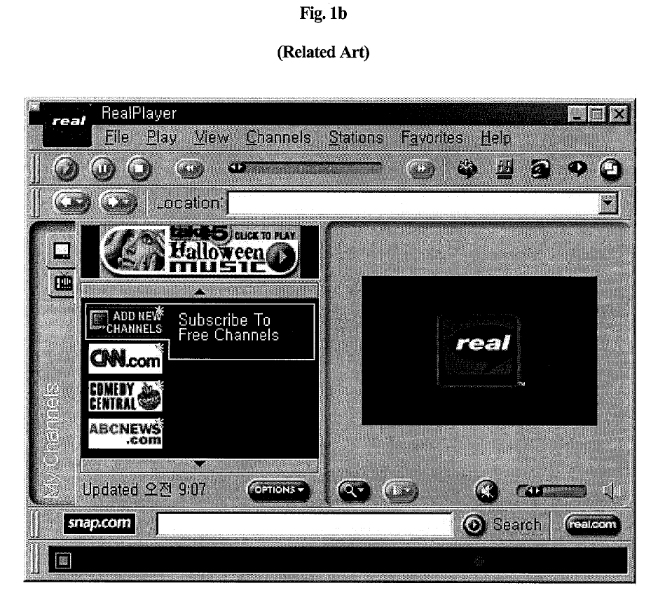

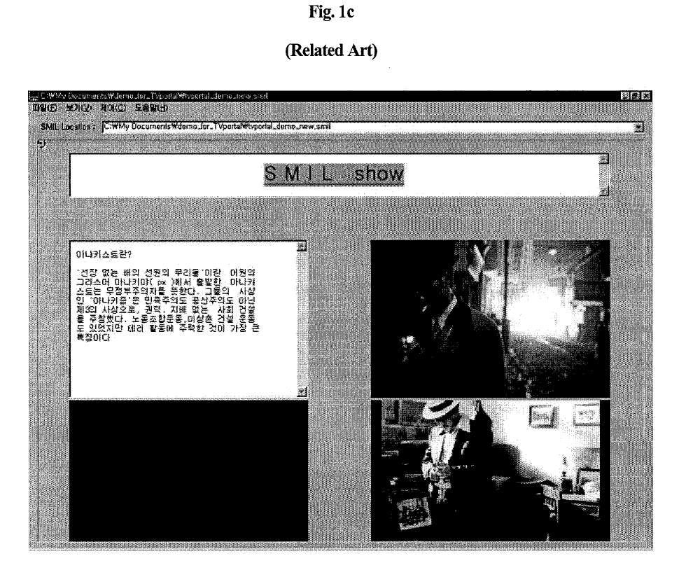

### DESCRIPTION OF THE PREFERRED EMBODIMENTS

The following detailed description of the embodiments of the invention is not intended to limit the scope of the invention, as claimed, but is merely representative of the presently preferred embodiments of the invention. The matters defined in the description are nothing but the ones provided to assist in a comprehensive understanding of the invention. Thus, it is apparent that the present invention can be carried out without those defined matters. Also, well-known functions or constructions are not described in detail since they would obscure the invention in unnecessary detail.

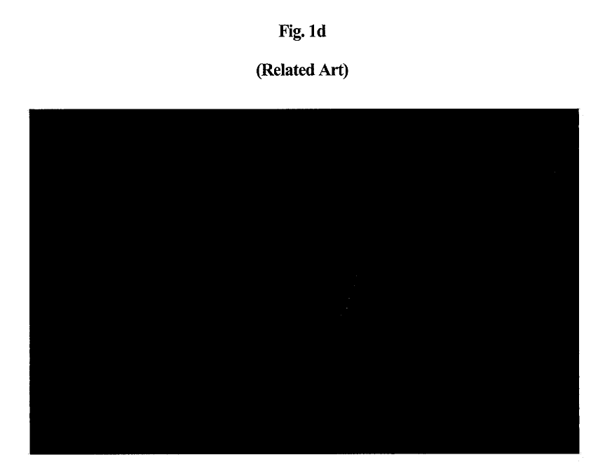

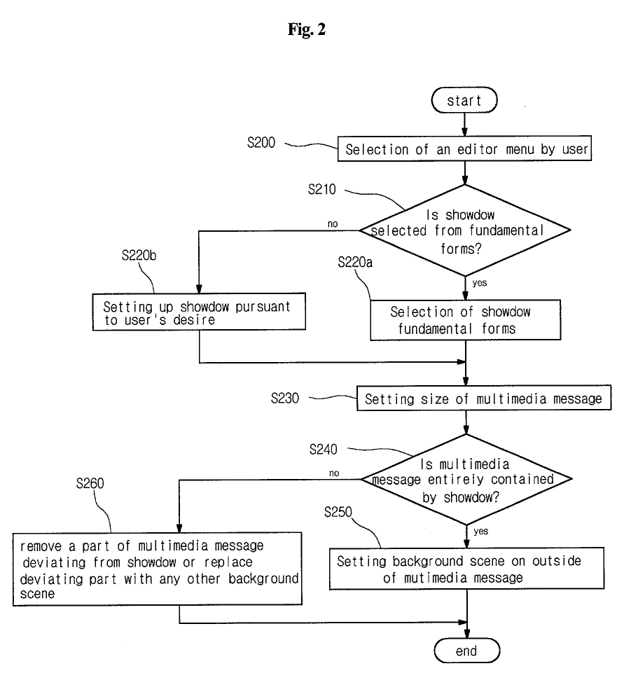

FIG. 2 is a flow chart illustrating a method of setting up a display window in accordance with the present invention.

As shown in FIG. 2, in order to set up the geometrical shape of the display window, a user selects an editor menu (S200). Hereinafter, a term “showdow” means a shape of a display window selected by a user and represents a compound word of “show” and “window”.

Then, the user determines whether the showdow is selected from fundamental forms setting on the editor (S210).

In the step of S210, in case the user selects the showdow from the fundamental forms setting on the editor, the user can select one among various-shaped fundamental forms such as a rectangle, a circle, an ellipse, a triangle, a diamond, etc. (S210a).

In case the user does not select the showdow from the fundamental forms setting on the editor, the user selects an option of creating a new form from the editor (S220b).

Hereinafter, a process of setting up the showdow when the user selects the showdow from the fundamental forms setting on the editor is described in detail.

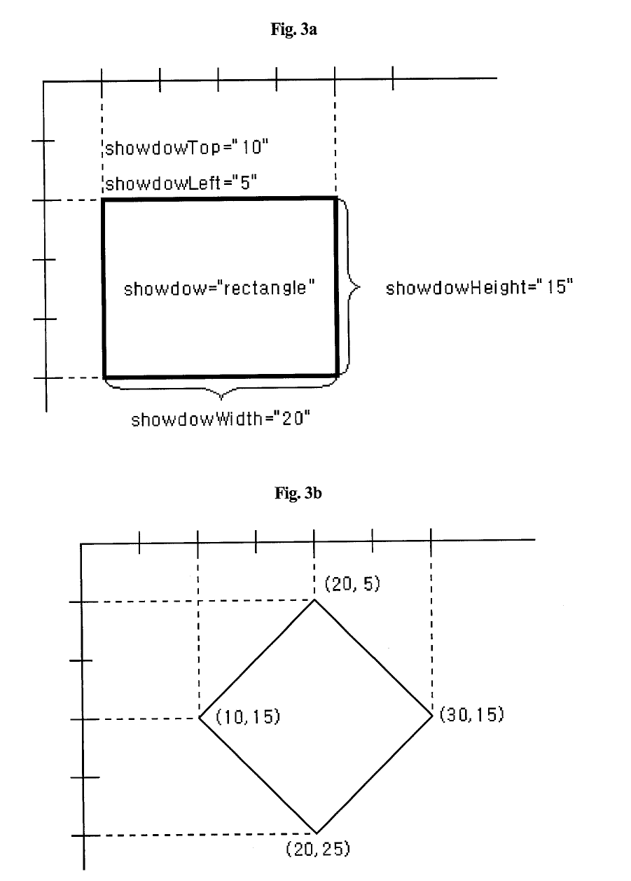

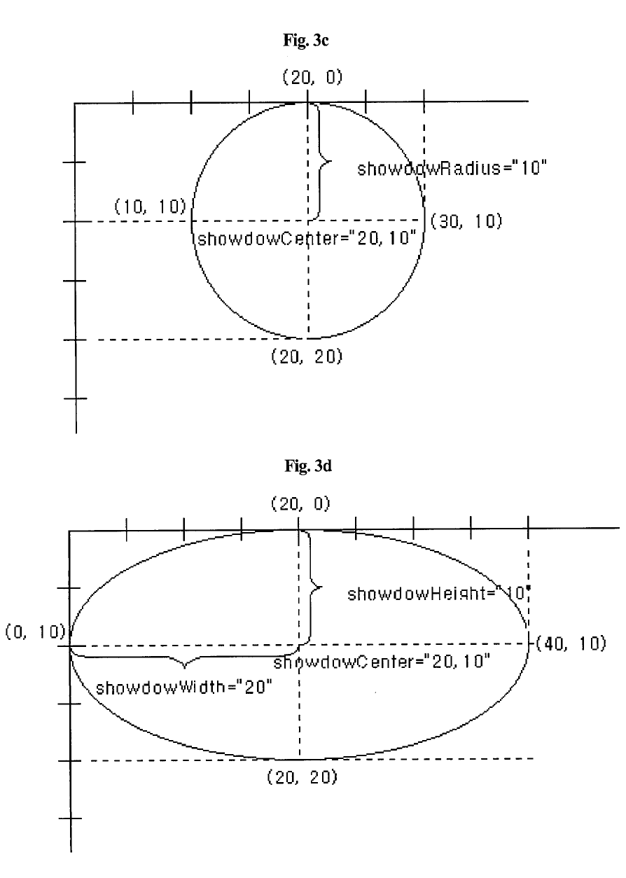

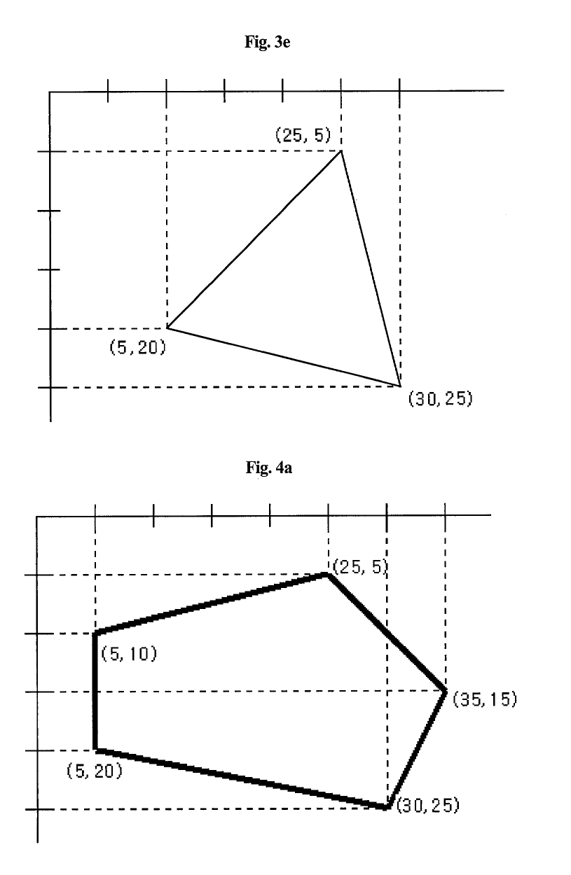

FIGS. 3a to 3e are views, each showing a method of setting up a shape of a display window from fundamental forms in accordance with a preferred embodiment of the present invention.

FIG. 3a illustrates a preferred embodiment of the present invention, in which the user selects a rectangle as the showdow, and shows positional information of the selected rectangle.

On a display screen showing a coordinate system, a value of X-axis (hereinafter, referred to as “showdowLeft′ attribute”) and a value of Y-axis (hereinafter, referred to as “showdowTop′ attribute”) of an upper leftmost point among four angular points of the rectangle are set.

Then, a width of the rectangle (hereinafter, referred to as “showdowWidth′ attribute”) and a height of the rectangle (hereinafter, referred to as “showdowHeight′ attribute”) are set. Herein, the values of all the attributes are more than zero.

Therefore, in consideration of the above-described particulars, the positional information of the rectangle according to this embodiment of the present invention is as follows.

showdow=“rectangle” showdowTop=“10” showdowLeft=“5” showdowWidth=“20” showdowHeight=“15”

FIG. 3b illustrates a more preferred embodiment of the present invention, in which the user selects a diamond as the showdow, and shows positional information of the selected diamond.

On the coordinate system, four angular points of the diamond are represented by four pairs of coordinate values. Herein, all the values of four points are also more than zero and three out of four angular points cannot be on the same line.

Therefore, in consideration of the above-described particulars, the positional information of the diamond according to this preferred embodiment of the present invention is as follows.

showdow=“diamond” showdowXY=“20,5/10,15/30,15/20,25”

FIG. 3c illustrates another preferred embodiment of the present invention, in which the user selects a circle as the showdow, and shows positional information of the selected circle.

As shown in FIG. 3c, coordinate values of a center point and a leftmost point of the circle are set. These values are also more than zero.

Therefore, in consideration of the above-described particulars, the positional information of the circle according to this preferred embodiment of the present invention is as follows.

showdow=“circle” showdowCenter=“20,10” showdowRadius=“10”

FIG. 3d illustrates still another preferred embodiment of the present invention, in which the user selects an ellipse as the showdow, and shows positional information of the selected ellipse.

As shown in FIG. 3d, coordinate values of a center point and a leftmost point of the ellipse, a width of the ellipse (hereinafter, referred to as “showdowWidth′ attribute”) and a length of the ellipse (hereinafter, referred to as “showdowLength′ attribute”) are set. These values are also more than zero and the positional information of the ellipse according to this preferred embodiment of the present invention is as follows.

showdow=“ellipse” showdowCenter=“20,10” showdowWidth=“20” showdowHeight=“10”

FIG. 3e illustrates a further preferred embodiment of the present invention, in which the user selects a triangle as the showdow, and shows positional information of the selected triangle.

As shown in FIG. 3e, three angular points of the triangle are represented by three pairs of coordinate values. Herein, all the values of three points are also more than zero.

Therefore, in consideration of the above-described particulars, the positional information of the triangle according to this preferred embodiment of the present invention is as follows.

showdow=“triangle” showdowXY=“25,5/5,20/30.25”

On the other hand, hereinafter, a process of setting up the showdow, when the user creates a new form as the showdow pursuant to the user's desire is described in detail.

If the user does not select the showdow from the fundamental forms setting on the editor, the user selects an option of creating a new form from the editor (S220b).

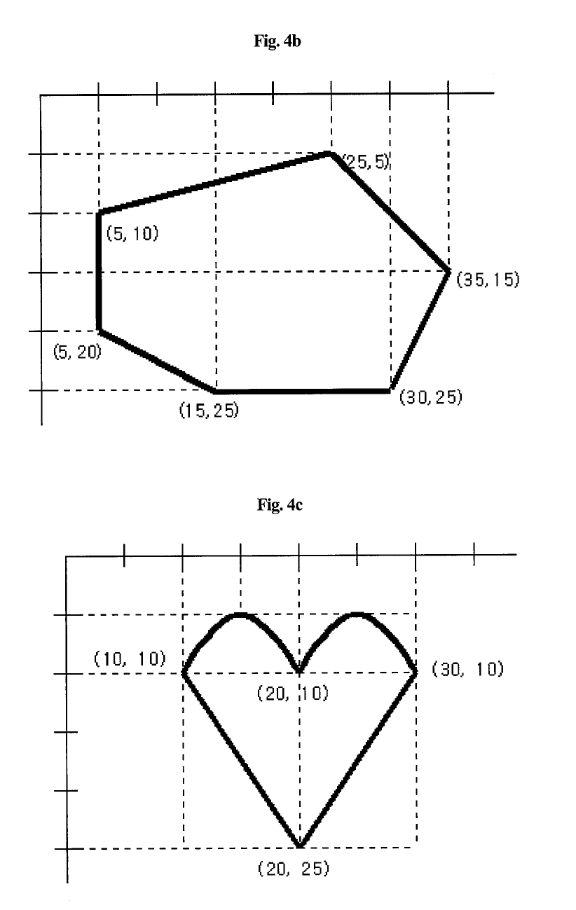

FIGS. 4a to 4c are views, each showing a method of creating a new shape of a display window pursuant to the user's desire in accordance with another preferred embodiment of the present invention.

Described in more detail, the user chooses one of a straight line or a curved line. Then, the user creates a new shape of the showdow pursuant to his or her desire.

FIG. 4a illustrates a still further preferred embodiment of the present invention, in which the user creates a pentagon as the showdow, and shows positional information of the created pentagon.

As shown in FIG. 4a, if the user wants to create a pentagon as the showdow, coordinate values of five angular points of the pentagon are set. Herein, the values of five points are also more than zero and three out of five angular points cannot be on the same line.

Therefore, in consideration of the above-described particulars, the positional information of the pentagon according to this preferred embodiment of the present invention is as follows.

showdow=“straight” showdowXY=“5,10/25,5/35,15/30.25/5,20”

Five points are connected in order to form the pentagon.

FIG. 4b illustrates another preferred embodiment of the present invention, in which the user creates a hexagon as the showdow, and shows positional information of the created hexagon.

As shown in FIG. 4b, if the user wants to create a hexagon as the showdow, coordinate values of six angular points are set. Herein, the values of six points are also more than zero.

Further, six angular points cannot be on the same line.

Therefore, in consideration of the above-described particulars, the positional information of the hexagon according to this preferred embodiment of the present invention is as follows.

showdow=“straight” showdowXY=“5,10/25,5/35,15/30,25/15,25/5,20”

Six points are connected in order to form the hexagon.

FIG. 4c illustrates a further preferred embodiment of the present invention, in which the user creates a heart as the showdow, and shows positional information of the created heart.

As shown in FIG. 4c, if the user wants to create a heart as the showdow, coordinate values of three points are set. The Y-axis values of the three points are the same. Herein, based on the central point, two points are spaced from the central point by the same interval. Then, another point with the same X-axis value as that of the central point is set.

Three points on the same line are connected in a curved line, thereby forming two curves. Then, two side points except for the central point are individually connected in a straight line to the other point with the same X-axis value as that of the central point. Thereby, the heart is created.

Therefore, in consideration of the above-described particulars, the positional information of the heart according to this preferred embodiment of the present invention is as follows.

showdow=“curve” showdowXY=“10,10/20,10/30,10” showdowCurvature=“10” showdow=“straight” showdow=“10,10/20,25/30,10”

Herein, “showdowCurvature” means a curvature of the curves. The larger the value of “showdowCurvature”, the larger the curvature is.

After the step of setting the shape of the showdow (S220a or S220b in FIG. 2), multimedia messages of different sizes are displayed on the set showdow.

In order to combine the multimedia message with the showdow, the size of the multimedia message is set so that the multimedia message is applicable to be displayed on the showdow (S230 in FIG. 2).

Hereinafter, a process of comparing the set size of the multimedia message to the size of the showdow and a process of displaying the multimedia message on the showdow are described.

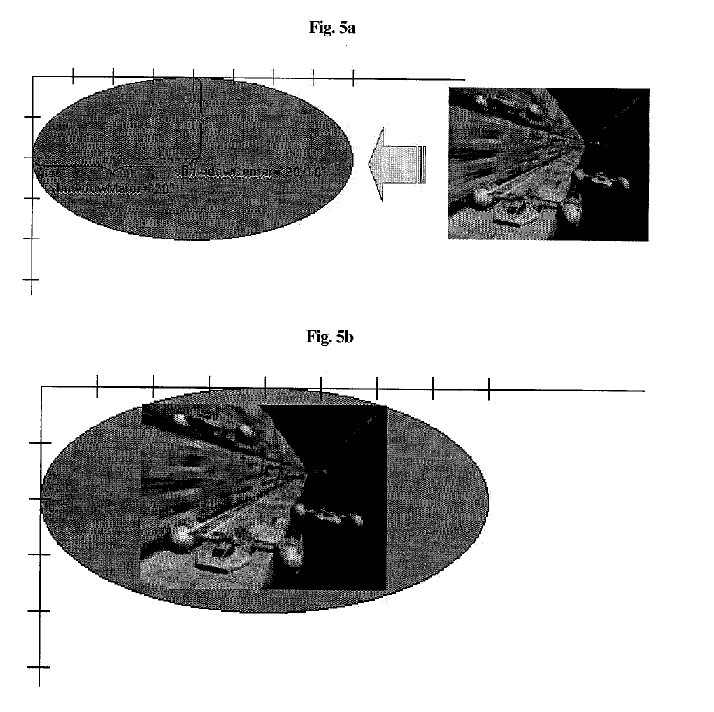

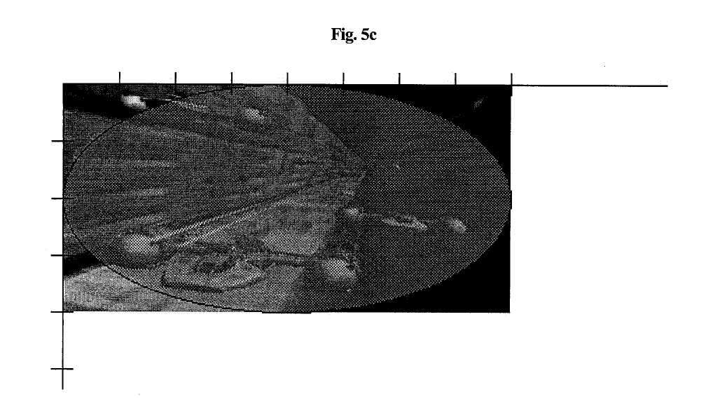

FIG. 5a illustrates a comparison between the size of the multimedia message and the size of the showdow. Whether the multimedia message is entirely contained by the showdow is determined (S240 in FIG. 2). Herein, the size of the multimedia message displayed on the showdow may be designated in a range of 0 to 100.

A visible area for displaying the multimedia message to the user is changed by the size of the multimedia message displayed on the showdow.

If the size of the multimedia message displayed on the showdow is set as 0, the multimedia message is entirely contained by the showdow. In this case, AND logic operation is performed between the multimedia message and the showdow by AND gate (also, referred to “conjunction gate”). Therefore, the rectangular multimedia message is entirely contained by the elliptical showdow.

FIG. 5b illustrates a case that the multimedia message is entirely contained within the elliptical showdow. The positional information of the showdow is as follows.

showdow=“ellipse” showdowCenter=“20,10” showdowWidth=“20” showdowHeight=“10” showdowDegree=“0”

In this case, the rectangular multimedia message is entirely displayed on the elliptical showdow (S250 in FIG. 2).

Preferably, any one is selected from predetermined background colors or background images. Then, the selected one is displayed on an area of the showdow on the outside of the multimedia message (S250 in FIG. 2).

More preferably, the conventional SMIL 1.0 is used as the background colors and the background images.

FIG. 5c illustrates a case that the showdow is entirely contained within the multimedia message.

With reference to FIG. 5c, if the size of the multimedia message is set as 100, the showdow is entirely contained by the multimedia message. In this case, OR logic operation is performed between the rectangular multimedia message and the elliptical showdow by OR gate (also, referred to as “disjunction gate”). Therefore, the multimedia message is maximally enlarged so that the showdow is entirely contained by the rectangular multimedia message.

In this case, the positional information of the showdow is as follows.

showdow=“ellipse” showdowCente=“20,10” showdowWidth=“20” showdowHeight=“10” showdowDegree=“100”

An area of the multimedia message on the outside of the showdow is removed. Alternatively, any one is selected from predetermined background colors or background images. Then, the selected one is displayed on this outside area (S260 in FIG. 2).

If the size of the multimedia message displayed on the showdow is set as any value between 0 and 100, any one is selected from predetermined background colors or background images. The selected one is displayed on an area of the showdow except for the multimedia message and an area of the multimedia message except for the showdow.

According to the method of setting up a display window of the present invention, different-shaped display windows such as a rectangle, a circle, an ellipse, a triangle, a diamond, etc. can be used.

Therefore, these various shapes of the display windows can be optionally applicable to display the multimedia message by types of contents and data types.

The user's terminal used in the present invention may be any terminal for transmitting or receiving the multimedia message.

Therefore, in case of employing a wireless communication network, personal information terminals, IMT-2000 terminals, mobile terminal equipments, or notebook computers provided with a radio modem may be used as the terminal of the present invention.

Otherwise, in case of employing a wire communication network, computers and televisions provided with a wire modem may be used as the terminal of the present invention.

Furthermore, the method of setting up the display window of the present invention may be applicable to display a more visual multimedia message, thereby improving visual effects.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A method of setting up a display window, said method comprising the steps of:
selecting an editor menu so as to set up a showdow;
determining whether said showdow is selected from fundamental forms setting on said editor;
setting a size of a multimedia message displayed on said showdow;
determining whether said multimedia message is entirely contained by said showdow; and
displaying said size-set multimedia message on said showdow.

2. The method of claim 1, wherein said showdow is selected from said fundamental forms setting on said editor.

3. The method of claim 2, wherein if said selected form is a rectangle, each value of X-axis and Y-axis of an upper leftmost point among four angular points of said rectangle, and a width and a height of said rectangle are set, and said values, said width, and said height of the rectangle are more than zero.

4. The method of claim 2, wherein if said selected form is a diamond, four angular points of said diamond are represented by four pairs of coordinate values, said values of four points are more than zero, and three out of said four points are not formed on the same line.

5. The method of claim 2, wherein if said selected form is a circle, coordinate values of a center point and a leftmost point of said circle are set, and said values are more than zero.

6. The method of claim 2, wherein if said selected form is an ellipse, coordinate values of a center point and a leftmost point of said ellipse, a width and a length of said ellipse, are set, and said values, said width, and said length of the ellipse are more than zero.

7. The method of claim 2, wherein if said selected form is a triangle, three angular points of said triangle are represented by three pairs of coordinate values, and said values of three points are more than zero.

8. The method of claim 1, wherein said showdow is created pursuant to a user's desire.

9. The method of claim 8, wherein if said created form is a pentagon, coordinate values of five angular points of said pentagon are set, said values of five points are more than zero, and three out of five angular points are not formed on the same line.

10. The method of claim 8, wherein if said created form is a hexagon, coordinate values of six angular points of said hexagon are set, said values of six points are more than zero, and said six angular points are not formed on the same line.

11. The method of claim 8, wherein if said created form is a heart, coordinate values of three points with the same value of Y-axis are set, two points are spaced symmetrically from the central point on the same line with the central point, a fourth point with the same value of X-axis as that of the central point is set, each two adjacent points are connected, respectively by a curved line, thereby forming two curves, and two side points except for the central point are individually connected in a straight line to said fourth point with the same value of X-axis as that of the central point.

12. The method of claim 11, wherein said heart requires a curvature, and the larger the value of said curvature, the larger the degree of curvature is.

13. The method of claim 1, wherein if said showdow is formed by a straight line, at least three points represented by values of a X-axis and Y-axis are set, thereby forming said showdow.

14. The method of claim 1, wherein if said showdow is formed by a curved line, a central point represented by values of X-axis and Y-axis is set and values of X-axis and Y-axis of two points symmetrically spaced from said central point on the same line with the central line are set, and then each of said two points is connected by a curved line to said central point.

15. The method of claim 1, wherein a visible area for displaying the multimedia message to the user is changed by the size of said multimedia message displayed on said showdow.

16. The method of claim 1, wherein if said multimedia message is entirely contained by said showdow, any one is selected from predetermined background colors and background images, then displayed on an area of said showdow except for said multimedia message.

17. The method of claim 1, wherein if said showdow is entirely contained by said multimedia message, any one is selected from predetermined background colors and background images, then displayed on an area of said multimedia message except for said showdow.

18. The method of claim 1, wherein if the size of said multimedia message displayed on said showdow is set as any value between 0 and 100, any one is selected from predetermined background colors and background images, then displayed on an area of said showdow except for said multimedia message and an area of said multimedia message except for said showdow.
